(19) United States
(12) Patent Application Publication
(10) Pub. No.: US 2019/0183153 A1
(43) Pub. Date: Jun. 20, 2019

(54) HEAT TREATMENT OF BULKY FOOD PRODUCTS

(71) Applicant: BÜHLER BARTH GMBH, Freiberg (DE)

(72) Inventor: Tobias LOHMÜLLER, Freiberg (DE)

(21) Appl. No.: 16/216,074

(22) Filed: Dec. 11, 2018

(30) Foreign Application Priority Data
Dec. 14, 2017 (DE) 10 2017 222 737.0

(51) Int. Cl. A23L 5/10; A23N 12/08

(52) U.S. Cl. CPC A23L 5/15; A23V 2300/24; A23V 2002/00; A23N 12/08

(57) ABSTRACT

A method for carrying out a heat treatment, in particular roasting of bulky food products, in particular cocoa, nuts, like almonds, hazelnuts, pecans or walnuts, coffee, seeds, cereals, malt, peanuts, brans, grains or oilseeds such as sunflower seeds, wherein the food products are subjected to a predetermined temperature for heat treatment. During the heat treatment, the partial pressure of water in the atmosphere where the food products are located is controlled such that during the heat treatment a substantially homogeneous moisture distribution forms in the food products. In particular, the partial pressure of water is adjusted such that during the heat treatment the escape of moisture from the food products is avoided.

This application claims priority from German patent application serial no. 10 2017 222 737.0 filed Dec. 14, 2017.

### FIELD OF THE INVENTION

The present invention relates to a method for carrying out a heat treatment of bulky food products, in particular the roasting of cocoa, nuts, coffee, cereals or oilseeds.

For the treatment of food in bulk form, such as coffee beans, cocoa beans, seeds and nuts, various kinds of heat treatment are important, in particular for example drying, roasting or methods of preservation, such as sterilisation or pasteurisation of such food.

### BACKGROUND OF THE INVENTION

During the heat treatment, the food is generally in a treatment chamber, for example a treatment drum. By supplying heat, for example supplying warm or hot air into the treatment chamber or alternatively or simultaneously heating the treatment chamber from the outside, heat is introduced into the bulk goods. In this regard efforts are made in order to distribute the heat impact as homogeneously as possible over the food present in the entire volume of the treatment chamber. This takes place at a temperature which has been exactly determined before or in a sequence of various temperatures in multi-stage treatment processes. Furthermore, the time of heat impact is controlled.

A method for roasting coffee beans is known for example from WO 2015/110337 A1. WO 2009/150192 A2 or WO 2010/108806 discloses, e.g. methods for drying pasta. Methods and means for drying rice are described, e.g. in WO 2007/065279 A1 and WO 2005/017431 A1.

The methods for heat treatment known so far have in common that the moisture distribution within the individual food products cannot be controlled. Thus, it is inevitable in the methods known so for that during the heat treatment the moisture at first decreases at the surface of the products and thus the moisture increases within the products towards the product kernel. The moisture distribution within the product, however, has—in interaction with the corresponding prevailing temperature—a great influence on the flavour development, on intracellular structures which, for example, correlate with the product's shelf life, and on the morphologic changes of the product.

### SUMMARY OF THE INVENTION

Thus, it is an object of the invention to provide a method for heat treatment of bulky food products, which enables an improved monitoring and controlling of the heat treatment and in particular the heat and moisture distribution and the dehumidification during the heat treatment.

This object is achieved with the features of the claims.

It is the gist of the present invention to control, while executing a heat treatment at a predetermined temperature, the partial pressure of water in the atmosphere where the food products are located during the heat treatment. In particular, by adjusting the partial pressure of water, a homogenous moisture distribution within the individual food products is to be achieved during the heat treatment.

The heat treatment can be in particular roasting, drying, pasteurisation or sterilisation. Depending on the type of heat treatment, the temperature and duration of the heat treatment are accordingly chosen. For example, the roasting of hazelnuts is carried out at about 130° C. The temperature may also be up to or even higher than 230° C., for example when roasting cereals. Furthermore, it is often the aim in such processes to quickly reach a target temperature in a product without any drying effects. During pasteurisation, for example, a temperature of about 95±5° C. is to be achieved as fast as possible before evaporation takes place. In order to obtain the pre-heating as quickly as possible, moisture can be added to the hot air so that the dew point of the air is adjusted at, for example, 65±5° C. and 95±5° C., during the heating phase. This setting prevents the drying of the products since the partial pressure of water in this phase is too low to induce a drying, but a high energy transfer is possible. Consequently, a speed gain by at least a factor of 2 can be obtained while the product's inner moisture remains constant.

In order to obtain the formation of a homogeneous moisture distribution within the food products, according to the invention particularly the partial pressure of water is adjusted such that a dehumidification from the food products is avoided during the heat treatment. This can be done by determining the moisture of the bulk goods regularly or continuously during the treatment, for example, as described in further detail below, by means of a direct measurement or indirectly, for example by comparing the moisture of supply air and exhaust air into and from the treatment chamber. When the moisture of the product to be treated decreases, the moisture and thus the partial pressure of water can be increased in the treatment chamber, and thus a further reduction of moisture in the products can be avoided.

Thus, the initial homogeneous moisture distribution is also maintained while the individual food products are heating. The heat treatment, i.e. in particular a roasting or a thermal process of the morphology change can occur when the distribution of both the temperature and the moisture has taken place homogeneously within the product. After having reached such a condition, the impact of the reaction occurs uniformly over the whole food product for the entire period of time of the heat treatment at an exactly defined moisture. Thus, for example, a drying can be started deliberately. In particular, when a drying is started as soon as the glass transition temperature of the product has been reached, the moisture of the products can be removed faster without destroying the intracellular structures. Further, in case of a roasting, the roasting temperature can react at the target moisture in the whole food product for the desired period of time. Also, in case of a critical phase of the morphological change, said condition can be controlled better since a homogeneous moisture content can be adjusted.

The setting of the partial pressure of water takes place, for example, on the basis of a measurement of the relative air moisture of the atmosphere surrounding the goods in the treatment chamber. This may be done directly within the treatment chamber or indirectly by measuring the moisture of the supply air of a hot air stream into the treatment chamber with which the temperature can be adjusted during the heat treatment and/or the exhaust air from the treatment chamber. The partial pressure of water can be adjusted by deliberately supplying vapour into the atmosphere, e.g. by a supply into the hot air stream.

Furthermore, the partial pressure of water can be adjusted on the basis of a determination of the moisture content of the food products. Moreover, the density of or density change in food products can be measured. The density and moisture can be measured, e.g. using microwave radiation with the commercially available product named HydroKen™. Further, the use of capacitive sensors is possible for moisture measurement. A direct measurement of the moisture can also take place for example by NIR radiation.

For certain types of heat treatment, the choice of the dew point temperature during the heat treatment can be advantageous. In order to be able to precisely and quickly adjust a certain product temperature without moisture loss, for example for pasteurisation of the food products, the atmosphere can be chosen such that the dew point temperature is the desired pre-heating temperature for the pasteurisation temperature. The high energy input due to the warm and moist atmosphere when using the dew point makes it possible that during the heat treatment the target temperature for the entire food product is achieved without fail so that a treatment, such as pasteurisation, at a desired temperature is guaranteed.

Furthermore, the choice of the glass transition temperature, i.e. the temperature at which the bulk good transfers from a brittle into a viscoelastic state, can be advantageous. Due to the warm and moist atmosphere, the drying of goods can be avoided and the glass transition temperature can be achieved more quickly by the increased energy density. After having reached the glass transition temperature, a drying can be carried out, which minimises an intracellular destruction, and which increases the shelf-life of, e.g. a nut, or reduces a fat migration from the nut in the chocolate.

Often a drying takes place after the heat treatment, in particular the roasting of the food products. During this drying, the partial pressure of water can be reduced in the atmosphere in order to guarantee a homogeneous drying of the products. In case of choosing a temperature at or above the glass transition temperature, the “porous” structure of the products enables a fast drying due to the increased water permeability without damaging the structure of the product.

### BRIEF DESCRIPTION OF THE DRAWINGS

In the following the present invention will be described with reference to the Figures, wherein

FIG. 1 schematically shows the distribution of moisture and temperature within a cocoa bean during a conventional roasting (A) and during a roasting according to an embodiment of the invention (B);

FIG. 2 schematically shows the course of the glass transition temperature T_{g} depending on the moisture;

FIG. 3 shows the time course of the moisture during roasting and drying with conventional methods and a method according to the invention;

FIG. 4 shows the time course of the moisture during roasting after initial drying and a hold time at a deliberately chosen constant temperature with a method according to the invention compared to a conventional method and

FIG. 5 shows the yield during a roasting with a method according to the invention with density measurement.

### DETAILED DESCRIPTION OF THE PREFERRED EMBODIMENTS

It is known that the effects of a heat impact in particular on bulky food do not only depend on and are influenced by the temperature in the individual food products and the time during which said temperature acts but also the moisture of the products. Whereas conventional methods aim at achieving a temperature as homogeneously as possible both in the entire treatment chamber provided for the heat treatment and within the individual bulk food, it is not possible with the conventional methods to adjust the moisture distribution within the bulk goods. The result of the heat treatment, however, is especially dependent on the moisture prevailing during the heat treatment. Thus, it has to be ensured that the required temperature can have an impact within the food for the desired time at an exactly defined moisture.

The present invention enables achieving a homogeneous moisture distribution within the individual food products.

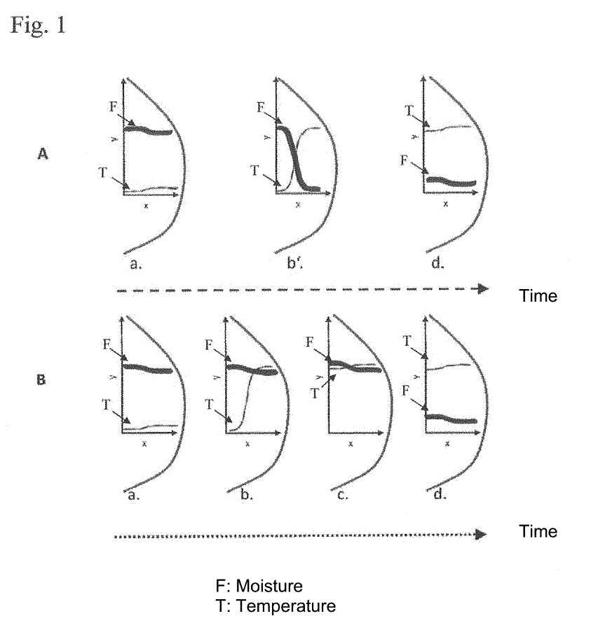

This is schematically shown in FIG. 1 with the example of the roasting of a cocoa bean.

FIG. 1A illustrates the distribution of the temperature and the relative moisture within a schematically depicted cocoa bean during a roasting process, wherein FIG. 1A—a depicts the situation of the initial product. Inside the cocoa bean a basically homogeneous temperature distribution prevails, the storage temperature of the starting product, and a homogeneous moisture of, e.g. about 7%. During a convective and/or conductive roasting (FIG. 1A-b′), heat is supplied to the cocoa bean at the surface, which inevitably leads to a temperature increase at the surface of the cocoa bean. At the same time, the moisture decreases where the temperature is at first increased, which will not take place inside the cocoa bean until the temperature has increased here as well over time (FIG. 1A-d). As a result, at the end of the roasting, the desired low moisture within the whole cocoa bean of, e.g. 2% is obtained, and the temperature distribution, too, inside the cocoa bean is homogeneous at the desired roasting temperature. However, it is apparent that during the course and especially at the beginning of the roasting, conditions prevail inside the cocoa bean which differ significantly from the surface to the core and therefore it cannot be guaranteed that the same results can be achieved with the roasting over the whole volume of the cocoa bean,

FIG. 1B shows the corresponding course when the method according to the invention is used. Taking the same initial conditions as the starting point (FIG. 1B-a) the temperature in the treatment chamber is increased so that again at first the temperature at the surface of the cocoa bean increases (FIG. 1B-b). By adjusting the partial pressure of water according to the method of the invention it is, however, guaranteed that during said heating phase no water leaks out of the product so that the moisture inside the cocoa bean remains constant at the initial level throughout the volume of the cocoa bean at, e.g. about 7%. Only when the desired temperature within the whole cocoa bean is reached and maintained for the desired period of time during the heat treatment, e.g. the roasting (FIG. 1B-c) is it ensured that the temperature impact has taken place at an exactly defined moisture throughout the whole cocoa bean. Only then will the drying of the cocoa bean be started, wherein the moisture decreases homogeneously through the whole volume of the cocoa bean until the desired final state (FIG. 1B-d) is reached. During the roasting and at the beginning of the drying (FIG. 1B-d) the temperature is, e.g. homogeneously at about 120° C. through the whole bean and the moisture homogeneously at, e.g. 7%.

In order to achieve that the partial pressure of water is suitably adjusted, the moisture can be monitored within the treatment chamber and, on the basis of said measurements, additional vapour can be supplied into the atmosphere in the treatment chamber, if need be. The moisture in the treatment chamber is monitored, e.g. by measuring the moisture of the hot air supplied in case of a convective heat treatment and/or measuring the moisture of the exhaust air. A direct measurement of the moisture within the treatment chamber is also possible.

As an alternative or in addition, the density or the density change of the products to be treated can be monitored which is, e.g. possible by using microwaves. The moisture inside the products can also be measured directly.

A control of the partial pressure of water is also possible empirically by determining through corresponding test series how to adjust the vapour supply at a certain temperature during the course of the procedure in order to achieve the desired result.

As regards the roasting exemplarily described before in view of cocoa beans, which can also be used for the treatment of coffee, nuts or cereals, the method according to the invention enables the deliberate adjustment of temperature and moisture within the products to be treated which can then be reliably maintained for a certain duration at the chosen values. The Maillard reactions occurring during roasting, which are, i.a. responsible for the flavour and colour development, can only be deliberately controlled when the moisture, the morphological status and homogeneity of the product with regard to moisture and temperature can be exactly controlled, which is enabled by the method of the invention. In order to obtain the desired homogeneous status in the products, a vapour/water-injection into a hot air stream is provided, as described above, through which the inside of the treatment chamber is heated or in the “closed room” of the treatment chamber heated from the outside. Thus, the heat treatment in the whole goods can be controlled and at the same time the homogeneous status can be maintained. Heating the goods with deliberate moisture loss is possible. After having reached the target temperature of, e.g. about 120° C., the moisture of the goods of, e.g. 5% can be maintained deliberately for, e.g. ten minutes, whereas so far the roasting has inevitably led to a drying which was additionally inhomogeneously through the bulk goods. The invention enables the exact control, which decisively influences the flavour development and appearance, e.g. colour development and shelf-life. For example, when roasting nuts, e.g. hazelnuts or peanuts, the desired colour can be achieved by exactly controlling the drying velocity and final moisture.

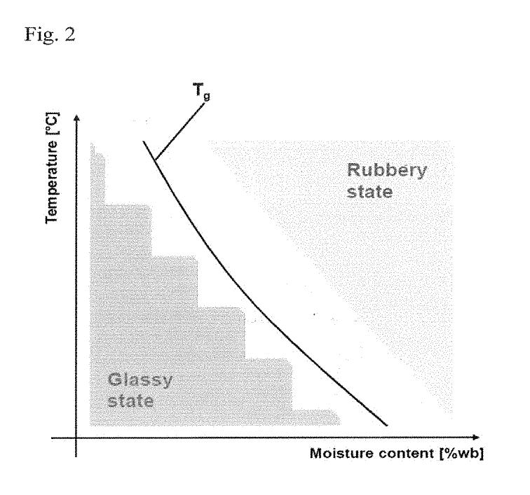

In various applications, it is particularly advantageous to choose the so-called glass transition temperature T_{g} of the products to be treated. At this temperature the deformation capability of the bulk goods to be treated changes. Below said temperature, the material behaves in a glassy manner, i.e. brittle, and above said temperature it is viscoelastic. The glass transition temperature changes, as shown in FIG. 2, depending on the moisture of the product. The choice of the glass transition temperature in a heat treatment leads to the minimisation of the intracellular destruction of, e.g. at least 25% in case of hazelnuts. This reduced destruction of the cellular structures in turn leads to a longer shelf-life, e.g. by a factor of 3 compared to conventional roasting processes. Thus, a reduced fat migration of, e.g. nuts in chocolate can be achieved.

In more detail, the glass transition temperature can be achieved quickly by supplying vapour or water into the atmosphere surrounding the goods to be treated due to the higher energy density of moist-warm air without negatively influencing the goods' properties.

Furthermore, the product has a “porous structure” at or above the glass transition temperature, wherein the retaining capability of water in the matrix of the goods to be treated is reduced and the goods have an increased water permeability.

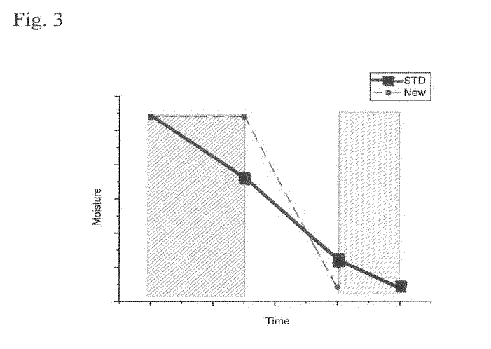

FIG. 3 shows the time course of the humidity within the bulk good to be treated during a conventional roasting (curve “STD”) and a roasting according to the present invention (curve “New”). As is shown in FIG. 3, when the method according to the invention is used the moisture within the goods to be treated remains initially constant (within the drawn shaded rectangle) until the glass transition temperature has been reached. Contrary thereto, in case of the conventional roasting, where no vapour is supplied, the moisture in the food product decreases continuously. Compared to conventional roasting processes, the entire process can be carried out altogether faster when using the present invention since, although there is no drying in the first step, the roasting product can be brought faster to the target temperature. The subsequent drying can take place faster at or above the glass transition temperature due to the product properties, which is symbolised with the patterned rectangle in FIG. 3. Due to the increased water permeability of the product, the drying can be achieved faster without structural damages to the product.

Maintaining the moisture during the roasting ensures that the raw material texture can be further maintained despite the roasting, whereby the roasting flavour can be obtained while the texture of the products remains the same.

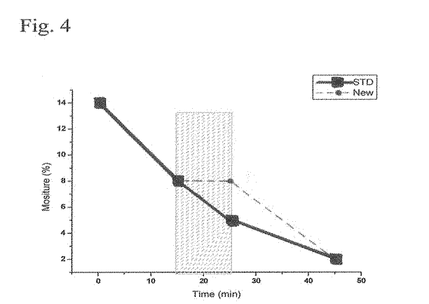

Furthermore, it can be advantageous to conduct a heat treatment, in particular a roasting, at a certain temperature and moisture for a certain defined period of time. This is exemplarily shown in FIG. 4. In this example, starting from a moisture of about 14%, the temperature is at first increased, wherein at the same time the moisture decreases. According to an embodiment of the invention, which is illustrated in FIG. 4 with the curve “New”, upon reaching the desired temperature during the period of time symbolised with the frame, the partial pressure of water is, e.g. controlled such by supplying water or vapour into the treatment chamber that the product moisture remains constant at a constant temperature. The drying takes place only after termination of the desired hold time, as described before with reference to FIG. 3. Contrary to conventional methods (curve “STD” in FIG. 4), not only the temperature but also the product moisture remains constant as a whole and also within the individual bulk goods during the hold time when the method according to the invention is used.

When certain products are roasted, e.g. coffee or cereals, significant morphological changes in a specific process step of the heat treatment can occur, leading to significant flavour changes, such as for example the so-called “crack” during coffee roasting. Moreover, roasting processes having an exothermic reaction involve the risk of pyrolysis processes, which may lead to a yield loss (“black malt”). Such a reaction, too, can be controlled by deliberately controlling the partial pressure of water according to the present invention, and be monitored online and avoided by means of the sensors according to the invention, in particular a density sensor, which may result in a yield increase.

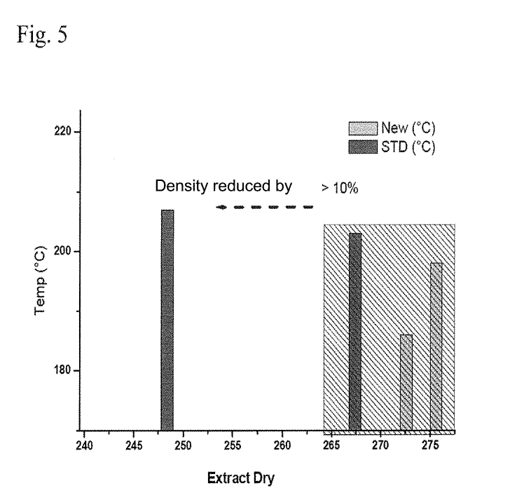

FIG. 5 illustrates the obtained yield (“Extract Dry”) through a roasting with conventional methods (“STD”) and using a method of the invention (“New”) by applying various temperatures. The desired yield is illustrated by the shaded rectangle. In conventional methods, the obtained yield is not only dependent on the duration of the treatment but also strongly on the temperature used. As shown, already a minor temperature increase of, e.g. only about 5° C. can massively reduce the yield when conventional methods are used. This is due to the fact that a higher temperature involves the danger of a pyrolysis reaction, which renders the affected goods useless.

This can he avoided by controlling the partial pressure of water according to the present invention. By means of a treatment in a moist atmosphere, the desired roasting can also be carried out at significantly different temperatures without considerable yield loss. Through additionally monitoring the density of the goods, a starting pyrolysis can be moreover detected and avoided by increasing the moisture in the treatment chamber.

Moreover, the method according to the invention enables a precise and fast adjustment of a certain product temperature without moisture loss by making use of the dew point, i.e. the conditions are set such that the water condenses at the desired temperature. This can he in particular important regarding methods for preservation, i.e. pasteurisation and sterilisation, wherein it has to be ensured that the whole product is subjected sufficiently long to a certain temperature. The application of moist hot air enables a fast transmission of energy to the goods. This high energy yield guarantees a simultaneous homogeneous temperature within a treatment chamber which can be used for controlling the roasting profile or also for the deliberate sterilisation. In a convective roasting, the adjustment of the dew point can be effected as described before via a vapour supply into the hot air stream. By correspondingly choosing the dew point at, e.g. 95±5° C. for the pasteurisation so that the water condenses at this temperature and the faster heat transition takes place, it is ensured that the desired temperature prevails also in the whole bulk good. Thus, the long hold time in conventional methods can be avoided where, e.g. higher temperatures have to be used for a longer duration in order to ensure the achievement of the necessary temperature within the bulk good.

The moisture-based control of the heat treatment processes, in particular the roasting processes, according to the present invention can thus lead to a better shelf-life. The Maillard reactions, which are decisive particularly for the flavour development of the product, can be better controlled. Furthermore, an improved yield can be achieved by controlling morphological changes via controlling the drying and avoiding pyrolysis processes. Further, a faster roasting can be achieved through using a higher energy density during heating and subsequent drying when the glass transition temperature has been reached. The colour development of the product can be controlled independently of the initial temperature and the desired product temperature can be adjusted without drying effect. This method enables the product roasting and at the same time maintaining the raw material texture, wherein a reduced fat migration, e.g. in chocolate, can be achieved by gentle roasting.

The method according to the present invention can be conducted in particular in a conventional treatment device comprising a treatment chamber, in particular a roasting chamber or roasting drum, a supply air duct for supplying hot air into the treatment chamber, an exhaust air duct and a device for supplying vapour into the supply air duct. The products “Solano” or “Tornado” by Bühler Barth GmbH are, e.g. particularly suitable. The used device further has to comprise at least one of the following measuring systems:

means for determining the density of the food products, in particular using microwave radiation,

means for determining the moisture content of the food products, in particular by using microwave radiation,

means for determining the relative air moisture in the treatment chamber,

means for determining the supply air moisture and

means for determining the exhaust air moisture.

Thus, it has to be ensured that a corresponding controlled vapour supply is possible and the parameters for monitoring the moisture can be measured by corresponding sensors.

1. A method for carrying out a heat treatment of bulky food products, in particular cocoa, nuts, like almonds, hazelnuts, pecans or walnuts, coffee, seeds, cereals, malt, peanuts, brans, grains or oilseeds such as sunflower seeds, the method comprising:
subjecting the food products to a predetermined temperature for heat treatment, and
controlling a partial pressure of water in an atmosphere where the food products are located during the heat treatment such that a substantially homogeneous moisture distribution occurs in the food products during a duration of the heat treatment.

2. The method according to claim 1, wherein the partial pressure of water can be adjusted such that during the heat treatment a deliberate moisture escape from the food products can be adjusted.

3. The method according to claim 1, wherein the partial pressure of water is controlled on a basis of a measurement of a relative air moisture in the atmosphere and/or a moisture content and/or a density of the food products, wherein the measurement of the moisture content or the density is carried out by using microwave radiation or capacitive sensors.

4. The method according to claim 1, wherein hot air is supplied to the atmosphere to achieve and/or maintain the predetermined temperature, and the partial pressure of the water is controlled on a basis of a moisture of a supply air and/or an exhaust air of a hot air stream.

5. The method according to claim 1, wherein the control of the partial pressure of the water takes place before and/or during the heat treatment by deliberately supplying vapor to the atmosphere.

6. The method according to claim 1, wherein, during the heat treatment, a substantially homogeneous distribution of the temperature in the food products prevails.

7. The method according to claim 6, wherein the temperature maintained during the heat treatment is one of a dew point temperature or a glass transition temperature of the food products.

8. The method according to claim 1, wherein the duration of the heat treatment is controlled on a basis of a density measurement of the food products.

9. The method according to claim 1, wherein the food products are dried after the heat treatment, and the partial pressure of water in the atmosphere is lower during the drying than the partial pressure of water in the atmosphere during the heat treatment.

10. The method according to claim 1, wherein the food products are dried after the heat treatment, and the partial pressure of the water in the atmosphere is controlled during the drying on a basis of a density change in the food products.

11. A device for carrying out the method according to claim 1, wherein the device comprises a treatment chamber, in particular a roasting chamber or roasting drum, a supply air duct for supplying hot air into the treatment chamber, an exhaust air duct and means for supplying vapor into the supply air duct, wherein the device further comprises at least one of the following measuring means:
means for determining a density of the food products,
means for determining a moisture content of the food products,
means for determining a relative air moisture in the treatment chamber,
means for determining a supply air moisture, and
means for determining a exhaust air moisture.

12. A device for carrying out the method according to claim 1, wherein the device comprises a roasting chamber or a roasting drum, a supply air duct for supplying hot air into the roasting chamber or the roasting drum, an exhaust air duct and means for supplying vapor into the supply air duct, wherein the device further comprises at least one of the following measuring means:
means for determining a density of the food products using microwave radiation,
means for determining a moisture content of the food products using microwave radiation,
means for determining a relative air moisture in the treatment chamber,
means for determining a supply air moisture, and
means for determining a exhaust air moisture.

13. The method according to claim 6, wherein the prevailing temperature in the food products is between 90° C. and 230° C.

14. A method of carrying out roasting of bulky food products which comprises one of cocoa, nuts, almonds, hazelnuts, pecans, walnuts, coffee, seeds, cereals, malt, peanuts, brans, grains, oilseeds and sunflower seeds, the method comprising:
subjecting the food products to a predetermined temperature for heat treatment thereof, and
controlling a partial pressure of water, in an atmosphere where the food products are located during the heat treatment, such that a substantially homogeneous moisture distribution occurs within the food products during a duration of the heat treatment.

15. The method according to claim 14, further comprising adjusting the partial pressure of water such that during the heat treatment a deliberate moisture escape from the food products is adjustable.

16. The method according to claim 14, further comprising controlling the partial pressure of water on a basis of a measurement of at least one of a relative air moisture in the atmosphere, a moisture content of the food products or a density of the food products, and
carrying out the measurement of the moisture content or the density by one of using microwave radiation or capacitive sensors.

17. The method according to claim 14, further comprising supplying hot air to the atmosphere for one of achieving and maintaining the predetermined temperature, and
controlling the partial pressure of the water on a basis of at least one of a moisture of a supply air and/or an exhaust air of a hot air stream.

18. The method according to claim 14, further comprising controlling the partial pressure of the water, by deliberately supplying vapor to the atmosphere, at least one of before and during the heat treatment.

19. The method according to claim 14, further comprising, during the heat treatment, achieving a prevailing temperature distribution in the food products of between 90° C. and 230° C.

20. The method according to claim 14, further comprising using one of a dew point temperature of the food products or a glass transition temperature of the food products as the temperature during the heat treatment.
